(19) United States
(12) Patent Application Publication
(10) Pub. No.: US 2025/0301298 A1
(43) Pub. Date: Sep. 25, 2025

(54) METHOD, INFORMATION PROCESSING DEVICE, AND STORAGE MEDIUM STORING PROGRAM

(71) Applicant: CANON KABUSHIKI KAISHA, Tokyo (JP)

(72) Inventors: Tomoya Kobayakawa, Kanagawa (JP); Yuhei Yoshimoto, Tokyo (JP)

(21) Appl. No.: 19/077,347

(22) Filed: Mar. 12, 2025

(30) Foreign Application Priority Data
Mar. 22, 2024 (JP) 2024-047092

(51) Int. Cl. H04W 8/00; H04W 48/20

(52) U.S. Cl. CPC H04W 8/005; H04W 48/20

(57) ABSTRACT

An information processing device including a first program and a second program, executes, by the first program, first search processing for searching for a communication device operating in a predetermined mode for receiving setting information from the information processing device; provides, by the first program, the second program with information related to the communication device discovered by the first search processing; and executes, by the second program, transmission processing without executing, by the second program, second search processing, the transmission processing being for transmitting information related to an external access point to the communication device identified based on the information related to the communication device discovered by the first search processing and the second search processing being for searching for the communication device on a network to which the information processing device belongs.

### BACKGROUND OF THE INVENTION

### Field of the Invention

The present invention relates to a method capable of executing setting for connecting a peripheral device to a wireless network, an information processing device, and a storage medium storing a program.

### Description of the Related Art

There are many types of devices (hereinafter referred to as peripheral devices) that can be used by being connected to a terminal device, such as a printer, a camera, a smart device, and a home appliance. All these peripheral devices can be connected to a local area network (LAN) by operating a terminal device or a peripheral device and can be used from a terminal device via the LAN. Further, a LAN may be constructed by a wireless network, in which case it is more convenient than a wired network in that it is not limited by the installation location of the device. However, it may be difficult for a user to operate a communication device such as a peripheral device to join a wireless network. Japanese Patent Laid-Open No. 2018-191252 describes that an application program (hereinafter referred to as an application or an app) installed on a terminal device detects a printer in a state (referred to as a wireless setting mode or a network setup mode) in which setting for connecting to a wireless LAN can be performed and describes performing setting for connecting a printer to a wireless LAN by passing, to the detected printer, information for connecting to a wireless LAN to which the terminal device is connected.

Here, a printer enters the wireless setting mode automatically when setting for connecting to a wireless LAN is necessary or by a user operating an operation unit of the printer. Further, detecting a printer in wireless setting mode means that the printer serves as an access point (AP) and an application of a terminal device detects that AP. The application establishes a Peer to Peer connection (P2P connection) from the terminal device to the printer serving as an AP and performs setting for connecting the printer to a wireless LAN by transmitting, to the printer, information on the wireless LAN (e.g., a Service Set Identifier (SSID) and a passphrase of an AP) to which the terminal device has been connected thus far. Further, after setting for connecting to a wireless LAN is completed, the printer exits the wireless setting mode and connects to an AP specified by the terminal device. The terminal device returns to connecting to the AP to which it has been connected thus far. Generally, when the use of a printer is started, processing including such setting for connecting to a wireless LAN and processing for installing a related application are necessary. An application responsible for these processes may be referred to as a setup application that performs processing for setting up a printer.

### SUMMARY OF THE INVENTION

The present invention provides a method for efficiently executing processing for setting up a peripheral device, an information processing device, and a storage medium storing a program.

The method according to the present invention a method of controlling an information processing device including a first program and a second program, the method comprising: executing, by the first program, first search processing for searching for a communication device operating in a predetermined mode for receiving setting information from the information processing device; providing, by the first program, the second program with information related to the communication device discovered by the first search processing; and executing, by the second program, transmission processing without executing, by the second program, second search processing, the transmission processing being for transmitting information related to an external access point to the communication device identified based on the information related to the communication device discovered by the first search processing and the second search processing being for searching for the communication device on a network to which the information processing device belongs.

According to the present invention, it is possible to efficiently execute processing for setting up a peripheral device.

Further features of the present invention will become apparent from the following description of exemplary embodiments with reference to the attached drawings.

### BRIEF DESCRIPTION OF THE DRAWINGS

FIG. 1 is a diagram illustrating a configuration of a system.

FIG. 2 is a diagram illustrating a hardware configuration of each device.

FIG. 3 is a diagram illustrating a software configuration of a terminal device.

FIG. 4 is a diagram illustrating a screen of a portal application.

FIG. 5 is a diagram illustrating transition of screens.

FIG. 6 is a flowchart for explaining processing of the portal application.

FIG. 7 is a diagram illustrating transition of screens.

FIG. 8 is a flowchart for explaining processing of an application A.

FIG. 9 is a diagram illustrating a screen of the application A.

FIG. 10 is a flowchart for explaining processing of the application A.

FIG. 11 is a flowchart for explaining processing of the portal application.

FIG. 12 is a diagram illustrating a screen of the portal application.

FIG. 13 is a diagram illustrating transition of screens.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

When a setup application is started, the setup application executes processing for identifying a peripheral device to be subjected to setup processing. However, in a case where the setup application is activated from another application, a peripheral device to be subjected to setup processing may have already been identified in the other application. In that case, processing in the setup application becomes repetitive or redundant.

According to the present disclosure, it is possible to efficiently execute processing for setting up a peripheral device.

### First Embodiment

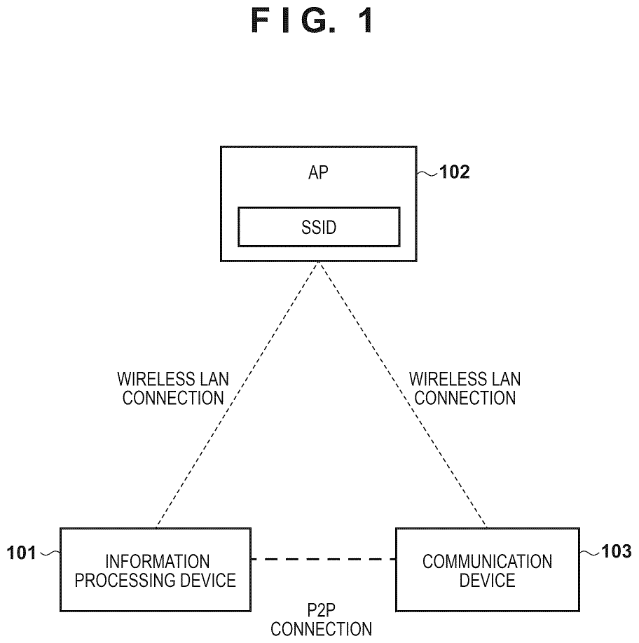

FIG. 1 is a diagram illustrating an example of a configuration of a communication system according to the present embodiment. In the present embodiment, the communication system is configured to include an information processing device 101, a communication device 103, and an access point (AP) 102 external to the information processing device 101 and external to the communication device 103. The AP 102 has a Service Set Identifier (SSID) for being identified by another device. By the information processing device 101 designating the SSID of the AP 102 and connecting to the AP 102 by wireless LAN, and the communication device 103 designating the SSID of the AP 102 and connecting to the AP 102 by wireless LAN, the devices can communicate with each other. Further, by either of them operating as an AP, the information processing device 101 and the communication device 103 can communicate with each other via a Peer to Peer connection (P2P connection). Further, when the communication device 103 includes an operation unit, a user can use the communication device 103 by directly operating the communication device 103. When able to communicate with the information processing device 101, the communication device 103 can be operated from the information processing device 101.

The information processing device 101 is a device having a wireless communication function using a wireless LAN or the like. In the following, a wireless LAN may be referred to as a WLAN. The information processing device 101 may be a personal information terminal (e.g., PDA (Personal Digital Assistant)), a mobile phone, a smartphone, a digital camera, a personal computer (PC), or the like. Further, the communication device 103 is a device having a wireless communication function using a wireless LAN or the like. The communication device 103 may be a scanner device, a projector, a mobile terminal, a smartphone, a notebook PC, a tablet terminal, a PDA, a digital camera, a music player, a TV, a smart speaker, or the like having a communication function. In the present embodiment, a PC will be described as an example of the information processing device 101, and a printing device (printer) having a print function will be described as an example of the communication device 103. Further, a printer may be an MFP having not only a print function but also a read function (a scanner), a FAX function, and a phone function. MFP is an acronym for Multi Function Peripheral. The AP 102 is specifically, for example, a wireless LAN router.

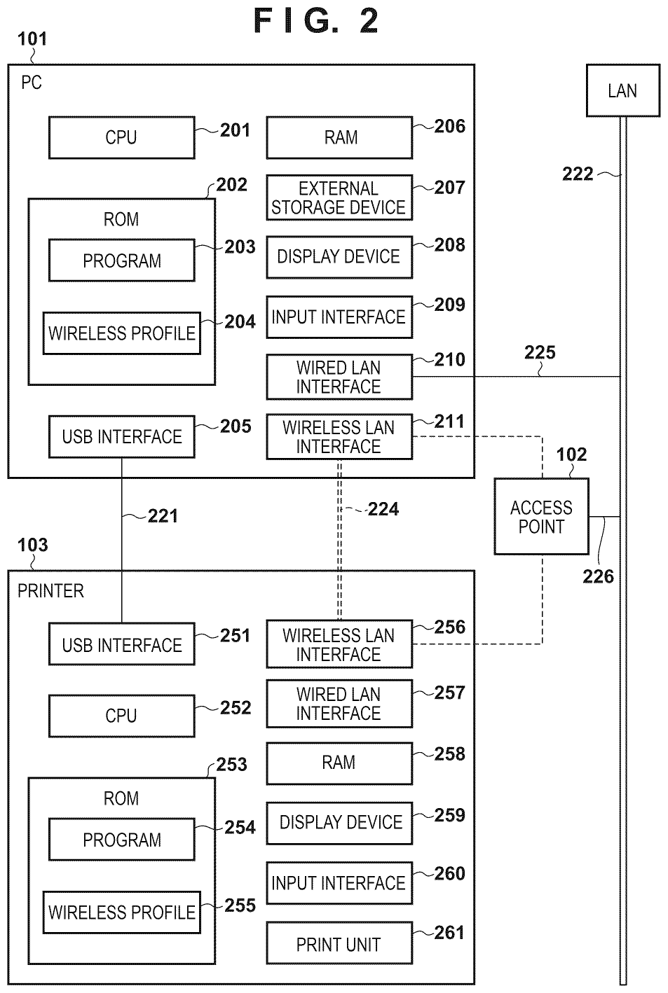

FIG. 2 is a diagram illustrating a hardware configuration of the communication system including the PC 101 and the printer 103 according to the present embodiment. The PC 101 includes a CPU 201, a ROM 202, a RAM 206, an external storage device 207, a display device 208, and an input interface 209. The CPU 201, the ROM 202, the RAM 206 and the like form a computer of the PC 101 that executes programs. The PC 101 also includes a Universal Serial Bus (USB) interface 205, a wired LAN interface 210, and a wireless LAN interface 211. The PC 101 is not limited to the configuration illustrated in FIG. 1 and appropriately includes functional blocks that can be executed by a device applied as the PC 101.

The CPU 201 is a processor that reads and executes control programs stored in the ROM 202 and controls the entire PC 101 according to the control programs and also executes processes illustrated in flowcharts to be described later. Then, as a result of the control programs being executed, various functions of the PC 101, such as control for communication with an external device such as the printer 103, generation of a print job to be output to the printer 103, and instruction of network setup, are realized. The RAM 206 is constituted by a DRAM, an SRAM, or the like, which requires a backup power supply, and is used as a memory area for storing temporary setting information, management data, and the like for when the PC 101 operates. The RAM 206 is also used as a temporary storage region, such as a main memory and a work area of the CPU 201, and is also used as a transmission buffer and the like for temporarily storing a print job generated to be transmitted to the printer 103.

The ROM 202 stores a program 203 corresponding to various processes and including a network setup processing program for transmitting setting information of an external access point (AP) to a printer, a wireless profile 204, and the like. Further, the external storage device 207 stores an operating system (OS), a printer driver, and various other types of data. The display device 208 is constituted by a light-emitting diode (LED), a liquid crystal display (LCD), or the like and displays various user interface screens of the OS and the program 203 and also notifies a state of the PC 101. The input interface 209 is an interface for receiving data input from the user and user instruction operations by an operation unit, such as a keyboard, being operated. The operation unit may be a physical keyboard, a physical button, or the like or may be a software keyboard, a software button, or the like displayed on the display device 208. That is, the input interface 209 may receive input from the user via the display device 208.

The network setup processing program is an application program for performing setting for connecting to an AP to which the printer 103 is to be connected and may include other functions in addition to a network setup function. Hereinafter, the network setup processing program will be referred to as a setup application. The setup application is stored in the ROM 202, for example, by being installed from an external server by Internet communication via the wireless LAN interface 211. Assume that the setup application is an application program provided by a vendor of the printer 103.

The ROM 202 also stores network information. As the network information, IP addresses assigned to the wireless LAN interface 211 and the wired LAN interface 210 of the PC 101 and an IP address and a subnet mask of the AP with which the PC 101 is connected are stored. As the network information, wireless profiles of APs with which the PC 101 had been connected are stored. In other words, the ROM 202 stores history information of APs with which the PC 101 had previously been connected. The wireless profile information includes SSIDs, security settings, and passwords of APs with which the PC 101 had been connected.

The wired LAN interface 210 and the wireless LAN interface 211 are configured to be connected with an external device, such as the printer 103 or the AP 102 and execute data communication. For example, the wireless LAN interface 211 is capable of connecting to an access point (not illustrated) in the printer 103. The wireless LAN interface 211 controls data transmission and reception conforming to a communication standard defined by IEEE 802.11 according to an instruction from the CPU 201. A wireless communication method used at that time is, for example, defined as WirelessFidelity (Wi-Fi)® by a world organization, Wi-Fi Alliance, and is defined as a wireless LAN standard. Further, the wireless LAN interface 211 includes an access point for connecting with a device, such as the printer 103, as an access point inside the PC 101. This use of an access point is commonly referred to as tethering. A wireless LAN interface 256 of the printer 103 can connect to the access points. By the wireless LAN interface 211 enabling the access point, the PC 101 operates as an access point. By connecting the wireless LAN interface 256 and the access point in the wireless LAN interface 211, it becomes possible for the PC 101 and the printer 103 to communicate with each other. When the wireless LAN interface 211 of the PC 101 is connected to the Internet, the printer 103 can also be connected to the Internet through the wireless LAN interface 211.

The PC 101 is capable of Peer to Peer connection (P2P connection or direct connection) with the printer 103 via a USB cable 221 or via a wireless direct connection 224, which uses the wireless LAN interface 211. The PC 101 is also capable of connecting to a LAN 222 via an Ethernet cable 225, and if the printer 103 can also connect to the LAN 222, the PC 101 and the printer 103 can communicate with each other on the same LAN 222 environment. Further, by the PC 101 connecting with the AP 102 using the wireless LAN interface 211, and the AP 102 connecting to the LAN 222 via an Ethernet cable 226, the PC 101 can connect to the LAN 222. Further, if the printer 103 can also connect to the AP 102, the PC 101 and the printer 103 can communicate with each other via the AP 102.

The printer 103 includes a CPU 252, a ROM 253, a RAM 258, a display device 259, an input interface 260, a USB interface 251, the wireless LAN interface 256, and a wired LAN interface 257. The CPU 252, the ROM 253, the RAM 258, and the like form a computer of the printer 103 that executes programs. The printer 103 is not limited to the configuration illustrated in FIG. 1 and appropriately includes functional blocks that can be executed by a device (e.g., a multi function peripheral (MFP)) applied as the printer 103.

The CPU 252 is a processor that reads and executes control programs stored in the ROM 253 and controls the entire printer 103 according to the control programs. Then, as a result of the control programs being executed, various functions of the printer 103, such as control for communication with an external device such as the PC 101, are realized. The RAM 258 is constituted by a DRAM, an SRAM, or the like, which requires a backup power supply, and is used as a memory area for storing temporary setting information, management data, and the like for when the printer 103 operates. The RAM 258 is also used as a temporary storage region, such as a main memory and a work area of the CPU 252, and may operate as a reception buffer for temporarily holding print information received from the PC 101 or the like, for example.

The ROM 253 is a non-volatile flash memory for storing fixed data such as the control programs to be executed by the CPU 252, data tables, and an embedded OS. In the present embodiment, the respective control programs stored in the ROM 253 perform software execution control, such as scheduling, task switching, and interrupt processing, under the control of the embedded OS stored in the ROM 253.

The ROM 253 stores a program 254, a wireless profile 255, and the like. Here, the wireless profile 255 is information including SSIDs, authentication information (e.g., passwords), and the like of APs with which the wireless LAN interface 256 had been connected. The wireless profile 255 is stored and managed by the CPU 252 executing the program 254 included in the ROM 253. For example, when the printer 103 is powered on, the printer 103 can reconnect to a previous network by using the wireless profile 255. Further, for example, the printer 103 may be configured to manage a plurality of wireless profiles, similarly to the OS of the PC 101.

The ROM 253 also stores a unique SSID that is uniquely set in the printer 103. Here, the unique SSID is uniquely defined for the printer manufacturer and the printer model, and the wireless LAN interface 256 of the printer 103 can operate as an AP corresponding to the unique SSID. Therefore, the PC 101 can connect to the printer 103 operating as an AP corresponding to the unique SSID via the wireless direct connection 224 as in the case of connecting to the AP 102.

The display device 259 is constituted by light-emitting diodes (LEDs), a liquid crystal display (LCD), or the like and displays various kinds of menus and also notifies the state of the printer 103. The input interface 260 is an interface for receiving data input from the user and user instruction operations by an operation unit, such as a keyboard, being operated. The operation unit may be a physical keyboard, a physical button, or the like or may be a software keyboard, a software button, or the like displayed on the display device 259. That is, the input interface 260 may receive input from the user via the display device 259.

A print unit 261 forms an image on a print medium, such as a cut sheet, by discharging a print agent, such as ink, onto the print medium based on image data and outputs a print result. In addition, the print unit 261 is configured to execute initial installation processing, which includes cleaning of a printhead and registration adjustment for adjusting an ink discharge position, when it is determined that a power-on is a power-on at the time of arrival. The print unit 261 may be configured to employ an inkjet printing method or another print method, such as an electrophotographic method. Further, the printer 103 is not limited to the configuration of FIG. 1 and includes other components (not illustrated).

A mode and connection method of executing wireless communication using the wireless LAN interface will be described below.

### <Regarding Direct Connection Method>

Direct connection refers to a form in which devices are wirelessly connected to each other directly without going through an external device, such as the AP 102. Direct connection is also referred to as Peer to Peer connection (P2P connection). The printer 103 is capable of operating in a mode (direct connection mode) for performing communication by direct connection as one of the connection modes. In Wi-Fi communication, there are a plurality of modes for performing communication by direct connection, such as software AP mode and Wi-Fi Direct (WFD) mode.

A mode in which direct connection is executed by WFD is called the WFD mode. WFD is a standard established by Wi-Fi Alliance and is a standard included in the IEEE 802.11 series communication standard. In the WFD mode, after a search for a device to be a communication partner has been performed according to a device search command, P2P group owner (GO) and P2P client roles are determined, and then remaining wireless connection processing is performed. A group owner corresponds to a Wi-Fi master station (master device), and a client corresponds to a Wi-Fi slave station (slave device). This role determination is called GO Negotiation. In the WFD mode in a state prior to role determination, the printer 103 is in a state in which it is neither a master station nor a slave station. Specifically, between devices that perform communication, first, one device issues a device search command and searches for a device with which to connect in the WFD mode. When the other device to be a communication partner is discovered, information related to services and functions that each device can provide is confirmed between the two. This confirmation of device provision information is optional and not mandatory. This device provision information confirmation phase corresponds to, for example, P2P Provision Discovery. Next, by confirming each other's device provision information, it is determined which will be a P2P client and which will a P2P group owner. When the client and the group owner are determined, they exchange parameters for communicating with each other via WFD. Remaining wireless connection processing and IP connection processing are performed between the client and the group owner based on the exchanged parameters. In the WFD mode, the printer 103 may always operate as a GO without executing the above-described GO Negotiation in the printer 103. That is, the printer 103 may operate in WFD mode that is Autonomous GO mode. That is, a state in which the printer 103 is operating in the WFD mode is, for example, a state in which connection via WFD is not established but the printer 103 is operating as a GO or a state in which connection via WFD is established and the printer 103 is operating as a GO.

In the software AP mode, between devices (e.g., the PC 101 and the printer 103) that perform communication, one device (e.g., the PC 101) is a client that fulfills a role of requesting various services. The other device realizes a function of an access point in Wi-Fi according to software settings. The software AP corresponds to a Wi-Fi master station, and a client corresponds to a Wi-Fi slave station. In the software AP mode, a client searches for a device to be the software AP according to a device search command. When the software AP is discovered, remaining wireless connection processing (e.g., establishment of wireless connection) is performed between the client and the software AP, and then IP connection processing (e.g., assigning of an IP address) is performed. Regarding commands and parameters to be transmitted and received when realizing wireless connection between the client and the software AP, those specified in a Wi-Fi standard may be used, and the description thereof will be omitted here.

In the present embodiment, when the printer 103 establishes and maintains direct connection, the printer 103 operates as a master station in a network to which it belongs. A master station is a device that constructs a wireless network and is a device that provides parameters used to connect to the wireless network to a slave station. The parameters used to connect to the wireless network are, for example, parameters related to the channel used by the master station. By receiving the parameters, a slave station connects to the wireless network constructed by the master station using the channels used by the master station. In the direct connection mode, the printer 103 operates as a master station, and so, the printer 103 can determine which frequency bands and channels to use for communication in the direct connection mode.

### <Regarding Infrastructure Connection Method>

Infrastructure connection is a connection form for devices (e.g., the PC 101 and the printer 103) that perform communication to connect with an access point (e.g., the AP 102) that controls a network of the devices and communicate with each other via the access point. The printer 103 is capable of operating in a mode (infrastructure connection mode) for performing communication by infrastructure connection as one of the connection modes.

In infrastructure connection, each device searches for an access point according to a device search command. When an access point is discovered, remaining wireless connection processing (e.g., establishment of wireless connection) is performed between the device and the access point, and then IP connection processing (e.g., assigning of an IP address) is performed. Regarding commands and parameters to be transmitted and received when realizing wireless connection between the device and the access point, those specified in a Wi-Fi standard may be used, and the description thereof will be omitted here.

In the present embodiment, when the printer 103 operates in infrastructure connection, the AP 102 operates as a master station and the printer 103 operates as a slave station. That is, in the present embodiment, infrastructure connection refers to connection between the printer 103 operating as the slave station and the AP 102 operating as the master station. When the printer 103 establishes an infrastructure connection and the PC 101 establishes an infrastructure connection with the AP 102, communication via the AP 102 becomes possible between the printer 103 and the PC 101. The channels used for communication in infrastructure connection are determined by the AP 102, and so, the printer 103 performs communication in infrastructure connection using the channels determined by the AP 102. In order to communicate with the printer 103 via the AP 102, the PC 101 needs to recognize (search and find) that the printer 103 belongs to a network that has been formed by the AP 102 and to which the PC 101 belongs.

### <Regarding Network Setup Mode>

The printer 103 can operate in network setup mode. A trigger for the printer 103 to start operation in the network setup mode may be, for example, that the user presses a button for the network setup mode or that the printer 103 activates (powers on) for the first time after arrival. The button for the network setup mode may be a hardware (physical) button provided in the printer 103 or a software button displayed by the printer 103 on the display device 259.

The printer 103 enables Wi-Fi communication when it starts operating in the network setup mode. Specifically, the printer 103 enables an AP (setup AP) inside the printer 103 dedicated to the network setup mode as Wi-Fi communication enabling processing. An SSID of the setup AP corresponds to the above unique SSID. With this, the printer 103 enters a state in which it is possible to establish a direct connection with the PC 101 via Wi-Fi. Assume that connection information (SSID and password) for connecting with the setup AP is held in advance in a portal application 321 or an application A 322 installed on the PC 101. That is, assume that the PC 101 knows in advance the connection information for connecting with the setup AP. Assume that, therefore, unlike connection information of an AP that is enabled in the direct connection mode, the connection information for connecting to the setup AP cannot be changed as desired by the user. In the network setup mode, the printer 103 may connect with the PC 101 via Wi-Fi Direct (WFD) instead of traditional Wi-Fi. That is, the printer 103 may operate as a group owner and receive network information from the PC 101 via WFD communication. Further, in the network setup mode, the printer 103 may be connected to the PC 101 via Bluetooth. Here, Bluetooth includes Bluetooth Classic and Bluetooth Low Energy (BLE). That is, for example, the printer 103 may operate as a slave device in BLE in the network setup mode and receive network information from the PC 101 via communication over BLE. Further, in the network setup mode, the printer 103 may be capable of executing both network setup via Wi-Fi and network setup via BLE. That is, the printer 103 may enable both Wi-Fi communication and BLE communication when it starts operating in the network setup mode. Specifically, the printer 103 may perform both enabling of the setup AP and enabling of an advertising state, in which advertisement information is transmitted via BLE so as to allow BLE connection, when it starts operating in the network setup mode. Further, the printer 103 may receive network information from the PC 101 by wired LAN or USB.

As described above, the printer 103 operates in a network setup mode for executing network setup of the printer 103 in accordance with predetermined conditions including pressing of a button by a user and initial installation. When operating in the network setup mode, the printer 103 controls the wireless LAN interface 256 and operates as a setup AP, which is enabled only during operation in the network setup mode. The setup AP is an access point that is different from an access point that is enabled during the above-described soft AP mode. Further, assume that the SSID of the setup AP includes a predetermined character string that can be recognized by the portal application 321 and the application A 322.

Further, assume that the printer 103 operating in the network setup mode uses a predetermined communication protocol (setup communication protocol) in communication with the PC 101 connected with the setup AP. The setup communication protocol is, more specifically, Simple Network Management Protocol (SNMP), for example.

The printer 103 stops operation in the network setup mode when a predetermined period of time elapses from the start of operation in the network setup mode and disables the setup AP. It also disables the setup AP when the connection information for connecting to an external AP and an instruction to change the wireless communication operation mode is received from the PC 101 during the network setup mode.

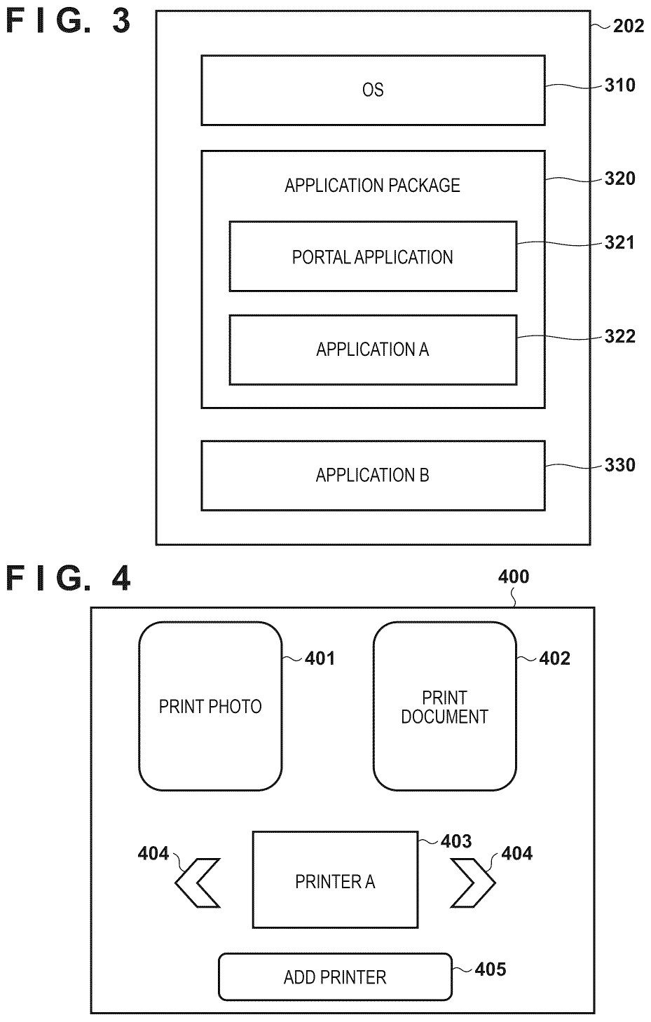

FIG. 3 is a diagram illustrating an example of a software configuration of the PC 101. That is, FIG. 3 illustrates an example of a configuration of the program 203. The software configuration of the PC 101 includes an OS 310, an application package 320, the portal application 321, the application A 322, and an application B 330. Description will be given assuming that Windows 10 is installed as the OS 310 as an example. The application package 320 includes the portal application 321 and the application A 322. That is, in the present embodiment, a plurality of applications providing different functions are provided to the user as one application. One method of providing the application package 320 to the user is, for example, a method of provision from the Internet via Microsoft Store®. In the present embodiment, it is assumed that by the application package 320 being downloaded and installed on the PC 101, the portal application 321 and the application A 322 are simultaneously downloaded and installed. The portal application 321 and the application A 322 are applications related to the printer 103 and provide functions that can be used in common by a plurality of printers 103. For example, the portal application 321 may display status information of the printer 103 (e.g., a status of a consumable of the printer) or instruct the printer 103 to execute a specific function (e.g., printing or scanning on the printer). The application A 322 provides a wireless network setup function including wireless LAN connection setting for connecting the printer 103 to a a predetermined AP 102. That is, the application A 322 corresponds to the above setup application.

In the present embodiment, it is assumed that the application A 322 can be activated based on an activation instruction issued from the portal application 321. An activation method of activation based on an activation instruction issued from the portal application 321 is referred to as cooperative activation from the portal application 321. It is also assumed that the application A 322 cannot be activated without being based on an activation instruction issued from the portal application 321. In other words, it is assumed that the application A 322 can be activated only by cooperative activation from the portal application 321.

The download method and the activation method for the portal application 321 and the application A 322 are not limited to the above form. The portal application 321 and the application A 322 may be separately downloaded and installed without being packaged. The application A 322 may be capable of being activated without being based on an activation instruction issued from the portal application 321. A method of activation without being based on an activation instruction issued from the portal application 321 is, for example, a method of activation based on an activation instruction issued based on the user operating an icon corresponding to the application A 322 displayed on a top screen of the PC 101. The icon corresponding to the application A 322 may be displayed, for example, in a list screen for displaying a list of programs included in the PC 101. An activation method of such activation without being based on an activation instruction issued from the portal application 321 is referred to as independent activation.

The application B 330 is an application capable of executing processes requiring particular rights, such as administrator rights in the OS 310. Examples of processes requiring administrator rights include processing for reading out profile information including particular information held in the ROM 202, such as a passphrase used when the PC 101 connects to a wireless LAN. At activation, the application B 330 confirms with the user on permission to execute processes with administrator rights on the display device 208. For example, Windows prompts selection as to whether to grant the application B 330 permission to execute processes with administrator rights through a guidance called user account control (UAC). When the user gives a permission instruction via the display device 208, the application B 330 starts processing with administrator rights. When the user does not give a permission instruction via the display device 208, the application B 330 does not start processing and terminates. The above application package 320 distributed from Microsoft Store® cannot execute processes with administrator rights. Therefore, when executing processing requiring administrator rights such as readout of profile information related to setting for connecting to a wireless LAN, the application A 322 included in the application package 320 realizes such processing via the application B 330. The application B 330 may be configured to be downloaded to the PC 101 from a server managed by the manufacturer of the printer 103 before the application A 322 executes processing or may be configured to be downloaded to the PC 101 from a server when processing is executed.

FIG. 4 is a diagram illustrating an example of a top screen displayed by the portal application 321. The portal application 321 displays, in a display region 403, an image or a character string by which the selected printer 103 can be recognized. The display region 403 displays, for example, a model image or a model name of the printer. In FIG. 4, “Printer A” is selected as an example. The portal application 321 also holds a list of selectable printers 103. The list of selectable printers 103 is, in other words, a list of printers 103 registered in the portal application 321. When a model switching button 404 is pressed, the selected target is switched among the printers 103 included in the list. Thereafter, the portal application 321 sets the selected printer 103 among the printers 103 included in the list as the communication partner. That is, specifically, for example, the portal application 321 transmits a print job or a scan job to the selected printer 103 in a print function or a scan function to be described later. Further, for example, the portal application 321 obtains status information from the selected printer 103 and displays the status of the selected printer 103. The displayed status is, for example, the status of the power state of the printer 103 or the status of ink held by the printer 103. The list of selectable printers 103 held by the portal application 321 is created by, for example, obtaining a list of print queues of printers managed by the OS 310 and extracting only the printers 103 including a particular character string in the names of the drivers of the printers 103 assigned to the respective print queues. With this, the portal application 321 can create, for example, a list in which only the printers 103 of the manufacturer can be selected.

The portal application 321 provides a function that can be used in common for a plurality of printers 103. The function is, for example, a print function for causing the printer 103 to execute printing or a scan function for causing the printer 103 to execute scanning. In the present embodiment, it is assumed that the print function includes a photo print function and a document print function. For example, when a print photo button 401 for executing the photo print function is pressed, the portal application 321 displays a screen for receiving an instruction as to which image file to print among image files (not illustrated) stored in the ROM 202. Then, the portal application 321 reads out the specified image file and transmits a print job for printing the image file selected above to the printer 103 selected using model switching buttons 404. Further, when a print document button 402 for executing the document print function is pressed, the portal application 321 displays a screen for receiving an instruction as to which document file to print among document files (not illustrated) stored in the ROM 202. Then, the portal application 321 reads out the specified document file and transmits a print job for printing the document file selected above to the printer 103 selected using the model switching buttons 404. In addition, when an add printer button 405 is pressed, the portal application 321 activates the application A 322 included in the application package 320. The activated application A 322 can add a new printer 103 to the above list of selectable printers 103 by executing setup processing for setting up the printer 103 and adding the printer 103 to print queues of printers managed by the OS 310.

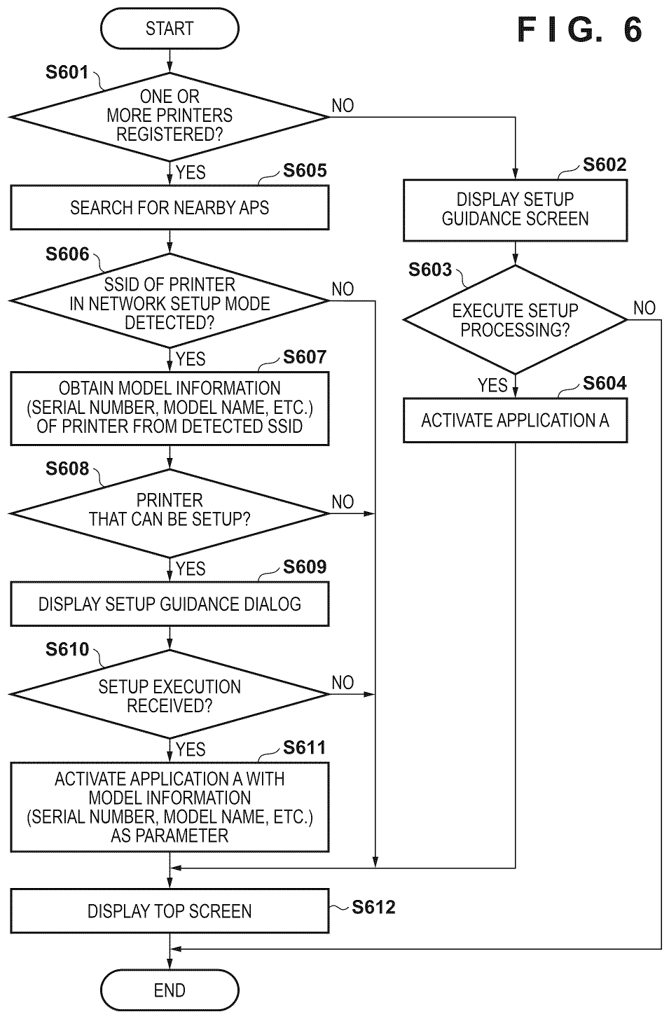

FIG. 6 is a flowchart for explaining processing for when the portal application 321 is activated. The portal application 321 starts the processing of FIG. 6 by being activated upon reception of an activation operation by the user. The processing of FIG. 6 is realized, for example, by the CPU 201 reading out a program stored in the ROM 202 to the RAM 206 and executing the program and will be described below as processing of the portal application 321 by the CPU 201.

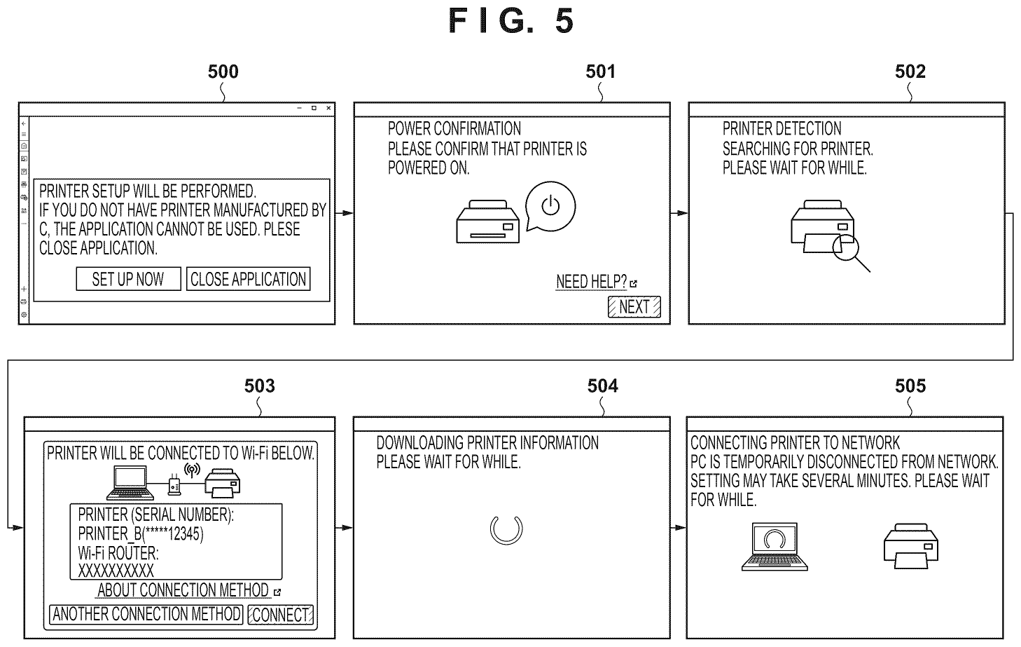

In step S601, the portal application 321 refers to the list of selectable printers and confirms whether one or more printers are registered in the list of selectable printers held by the portal application 321. If it is determined that not even one printer is registered, the processing proceeds to step S602. In step S602, a setup guidance screen 500 as illustrated in FIG. 5 is displayed. The screen includes text indicating to the user that a printer setup will be performed, a “set up now” button, and a “close application” button are included. The screen may include text indicating that the portal application 321 cannot be used if the user does not have a printer supported by the portal application 321, text prompting the user to register a printer in the portal application 321, and the like. At this timing, since the portal application 321 has not discovered a setup target printer, identification information of a printer is not displayed on the setup guidance screen 500.

In step S603, the portal application 321 determines whether to execute the setup processing based on the user operation received on the setup guidance screen displayed in step S602. Specifically, for example, if it is determined that the “close application” button has been pressed, it is determined to not execute the setup processing, and if it is determined that the “set up now” button has been pressed, it is determined to execute the setup processing.

If it is determined in step S603 to execute the setup processing, in step S604 the portal application 321 executes processing for activating the application A 322. The activation instruction issued here includes an activation parameter including information indicating that it is an activation instruction from the portal application 321. In the present embodiment, the activation parameter issued in the processing does not include the model information of the printer 103. The application A 322 is activated by the activation instruction being issued. After step S604, in step S612 the portal application 321 displays a top screen 400 and then terminates the processing of FIG. 6. If it is determined in step S603 to not execute the setup processing, activation of the portal application 321 is terminated, and the processing of FIG. 6 is terminated.

The determination executed in step S601 is not limited to the above form. The determination executed in step S601 may be processing for determining whether activation of the portal application 321, which triggered the start of processing of the present flowchart, is a first-time activation. A configuration may be taken such that if it is determined that the activation of the portal application 321 is a first-time activation, the processing proceeds to step S602, and if it is determined that the activation of the portal application 321 is not a first-time activation, the processing proceeds to step S605. Further, the determination performed in step S601 may be processing for determining whether there are one or more print queues corresponding to printers supporting the portal application 321 among the print queues managed by the OS 310. Printers supported by the portal application 321 are, for example, some models of printers among printers provided by the same vendor as the vendor providing the portal application 321. However, printers supporting the portal application 321 are not limited to this form and may be all printers provided by the same vendor as the vendor providing the portal application 321.

If it is determined in step S601 that one or more printers are registered, in step S605 the portal application 321 executes processing for searching for APs existing around the PC 101. Specifically, the portal application 321 instructs, for example, the OS, to search for APs existing around the PC 101. In response to this instruction, the OS performs a search for APs existing around the PC 101 and notifies the portal application 321 of information on all discovered APs. Here, the search executed by the OS is a search executed by obtaining information (AP information) of nearby APs by passive scanning. Passive scanning is reception of Beacon frames transmitted periodically by APs. AP information includes information such as an SSID, an encryption method, and a signal strength. As described above, a printer in network setup mode operates as a setup AP, and a setup AP has an SSID including a predetermined character string recognizable by the portal application 321 or the application A 322. For example, the SSID of a setup AP includes a character string indicating the vendor (manufacturer) of the printer, a character string indicating the model of the printer, and a character string indicating the serial number of the printer. The predetermined character string is, for example, a character string indicating the vendor of the printer and a character string indicating the model of the printer. Specifically, when the manufacturer is “AAA”, the model of the printer is “PRINTER_B”, and the serial number is “XXXXX . . . 12345”, the SSID of the setup AP is defined as “AAA_PRINT ER_B_12345” using the manufacturer name, the model name, and a part of the serial number. “XXXXX . . . 12345” in the above example indicates that the last five digits of the serial number are “12345”. With such a rule for SSIDs, respective printers can be identified even if printers of the same manufacturer and model are in the network setup mode. The above SSID is an example, and an SSID need only allow the model name and a part of the serial number to be recognized.

In step S606, the portal application 321 determines whether an AP corresponding to the SSID of a printer in network setup mode has been detected (discovered) by a search for APs existing around the PC 101. Specifically, the portal application 321 determines whether a character string indicating the vendor of the printer included in the received AP information matches a predetermined character string indicating printers supporting the portal application 321. More specifically, for example, it is determined whether an AP corresponding to the SSID starting with “AAA_” has been detected. When a character string matching a predetermined character string indicating printers supporting the portal application 321 is included in the received AP information, it is determined that an AP corresponding to the SSID of a printer in network setup mode has been detected. In this determination, it may be determined whether a character string indicating the model of the printer matches a predetermined character string indicating printers supporting the portal application 321.

If it is determined in step S606 that the SSID of a printer in network setup mode has not been detected, the state is that there is a printer registered in the portal application 321 but there is no printer in network setup mode in the vicinity. In that case, in step S612 the portal application 321 displays the top screen 400 and then terminates the processing of FIG. 6.

If it is determined that one or more SSIDs corresponding to APs of printers in network setup mode have been detected, in step S607 the portal application 321 obtains model information from the SSIDs detected in step S606. In the present embodiment, the model information is information including the model name of the printer and a part of the serial number. Specifically, for example, if the SSID is “AAA_PRINTER_B_12345”, the model name “PRINTER_B” and a part of the serial number “12345” are obtained as the model information.

In step S608, the portal application 321 determines, based on the model name obtained in step S607, whether the printer transmitting the AP information including the SSID including the predetermined character string is a printer supporting the portal application 321. Specifically, in the above example, it is determined whether “PRINTER_B” is included in a list of setup processing-supported model names predetermined in the portal application 321.

Alternatively, a configuration may be taken so as to reference a list of setup processing-supported model names predetermined in the application A 322 and determine whether “PRINTER_B” is included.

In step S608, if it is determined NO, the state is that there is a printer registered in the portal application 321 but there is no supported printer in network setup mode in the vicinity. In that case, in step S612 the portal application 321 displays the top screen 400 and then terminates the processing of FIG. 6. If it is determined that the printer whose SSID has been detected is supported by setup processing, in step S609 the portal application 321 displays a setup guidance screen.

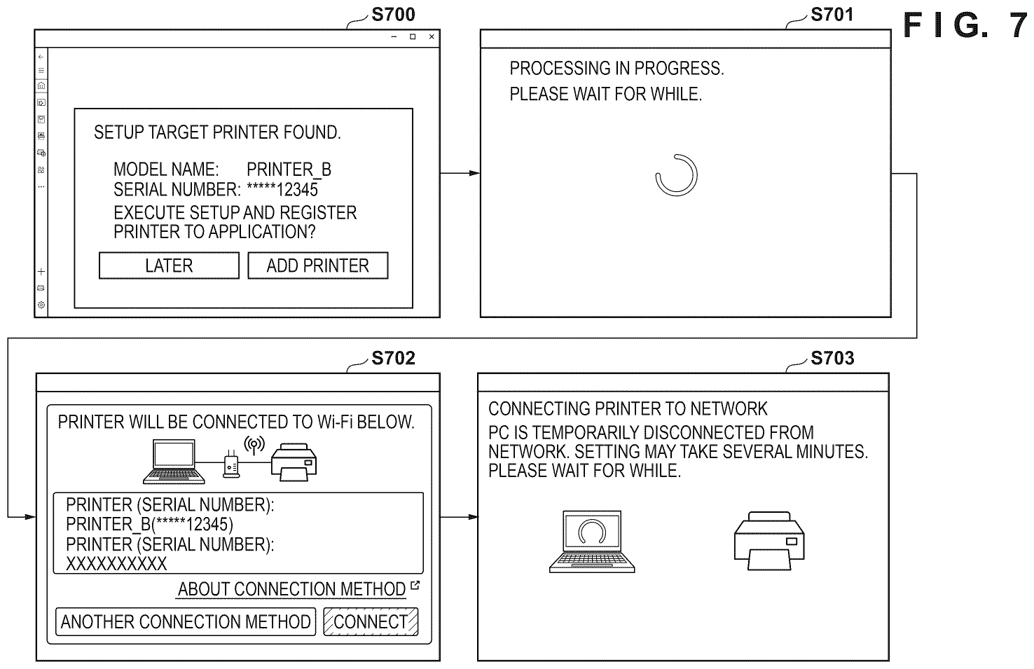

A screen 700 of FIG. 7 is a diagram illustrating an example of a setup guidance screen displayed by the portal application 321 in step S609. The setup guidance screen 700 includes text indicating that a printer that can be set up has been discovered and the identification information of that printer, a “later” button, and an “add printer” button. In the setup guidance screen 700, the model name “PRINTER_B” and a part of the serial number “12345” are displayed as an example of identification information of the printer. In the setup guidance screen 700, the identification information of the printer need not be displayed. The “later” button is a button by which an instruction selecting to not perform a setup can be received, and the “add printer” button is a button by which an instruction selecting to perform a setup can be received.

In step S610, the portal application 321 determines whether to execute the setup processing based on the user operation received on the setup guidance screen displayed in step S609. Specifically, for example, if it is determined that the “later” button is pressed, it is determined that the setup processing is not to be executed, and if it is determined that the “add printer” button is pressed, it is determined that the setup processing is to be executed.

If it is determined in step S610 to execute the setup processing, in step S611 the portal application 321 executes processing for activating the application A 322. Specifically, the portal application 321 issues an activation instruction for activating the application A 322. The activation instruction issued here includes an activation parameter including the model information obtained in step S607 and information indicating that it is an activation instruction from the portal application 321. The OS activates the application A 322 by using the activation parameter in the issued activation instruction. Then, in step S612, the portal application 321 displays the top screen 400. The processing for activating the application A 322 with the model information included in the activation parameter is, in other words, processing for passing the model information to the application A 322 when activating the application A 322. That is, the activation of the application A 322 in step S611 is different from the activation of the application A 322 in step S604 in that the model information is included in the activation parameter for activating the application A 322. An example in which in step S611 the model information is included in the activation parameter has been described, but processing may be such that the model information is not included in the activation parameter. For example, a configuration may be taken such that the portal application 321 passes the model information to the application A 322 together with the activation parameter.

If it is determined in step S610 to not execute the setup processing, the portal application 321 does not activate the application A 322 and in step S612 displays the top screen 400 and then terminates the processing of FIG. 6. In the present embodiment, if one or more printers are registered, a printer in network setup mode and supported by setup processing has been detected in the vicinity, and a setup processing execution instruction by the user has been received, the portal application 321 activates the application A 322 with the model information included in the activation parameter. If not even one printer is registered, in step S604 the portal application 321 activates the application A 322. That is, the activation of the application A 322 in step S604 is different from the activation of the application A 322 in step S611 in that the model information is not included in the activation parameter for activating the application A 322.

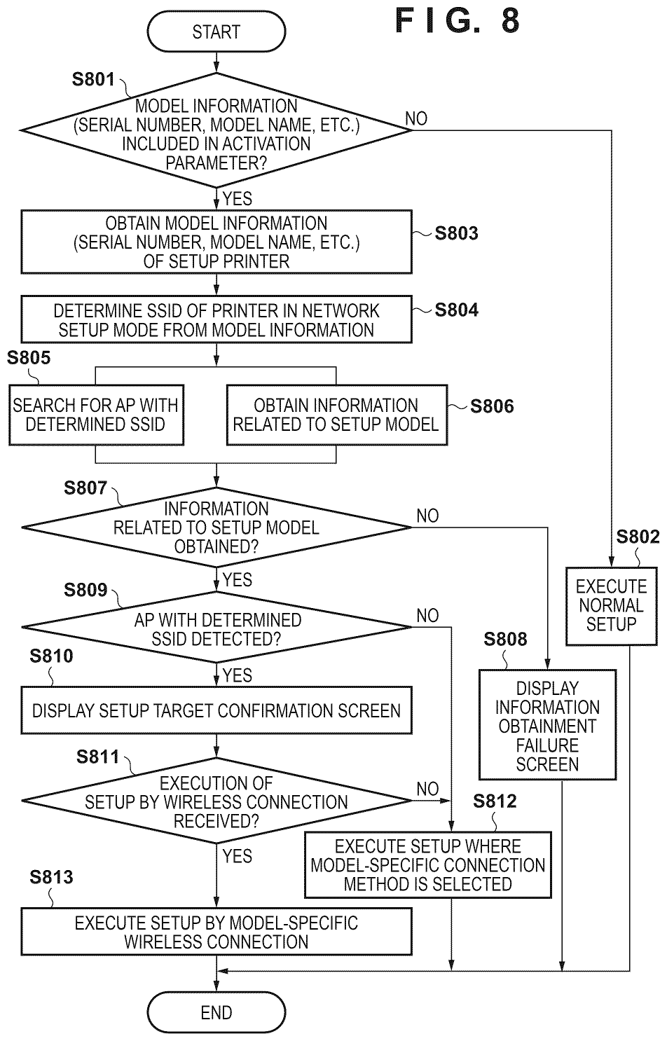

FIG. 8 is a flowchart for explaining processing to be executed by the application A 322. For example, the processing of FIG. 8 is started when the application A 322 is activated in cooperation from the portal application 321 in step S611 or S604 of FIG. 6. The processing of FIG. 8 is realized, for example, by the CPU 201 reading out a program stored in the ROM 202 to the RAM 206 and executing the program and will be described below as the processing of the application A 322 by the CPU 201.

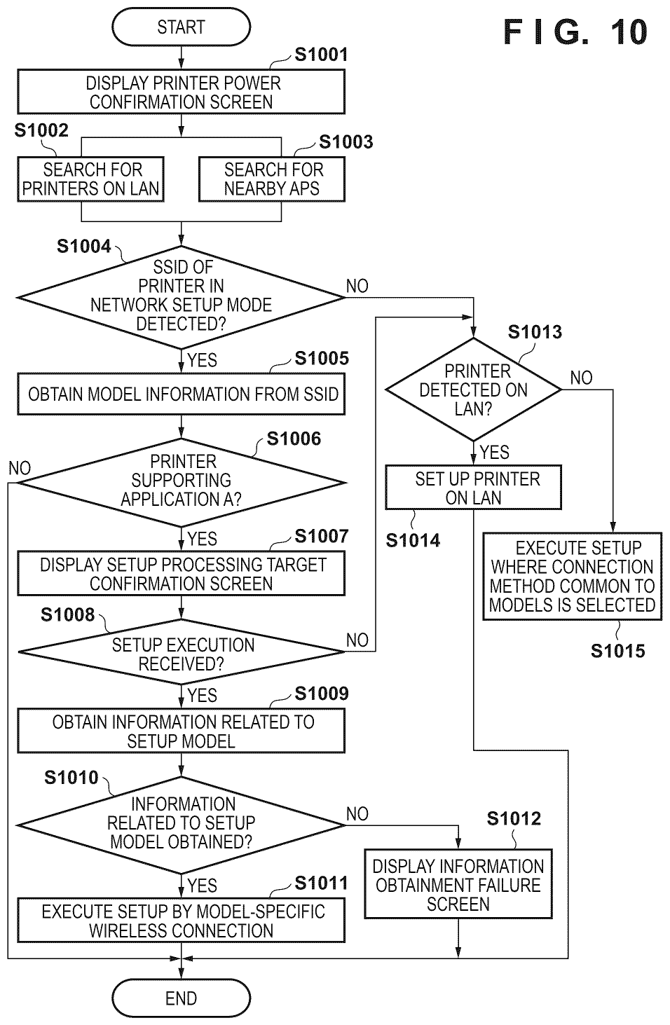

In step S801, the application A 322 determines whether the activation parameter used to start the application A 322 includes model information. Here, the model information is, for example, a model name and a part of a serial number. If it is determined that the activation parameter does not include model information, in step S802 the application A 322 executes normal setup processing. A case where the processing proceeds to step S802 is, for example, a case where the processing of step S604 of FIG. 6 has been executed. The processing of step S802 will be described later with reference to FIG. 10. As described above, the application A 322 may be capable of being independently activated. The parameter used for independent activation does not include model information. Therefore, when the application A 322 is independently activated, the processing proceeds to step S802.

If it is determined in step S801 that the activation parameter includes model information, the processing proceeds to step S803. A case where the processing proceeds to step S803 is, for example, a case where the processing of step S611 of FIG. 6 has been executed.

In step S803, the application A 322 displays a processing-in-progress screen 701. Then, the application A 322 obtains the model information of the setup target printer from the activation parameter.

In step S804, the application A 322 determines the SSID of the printer in network setup mode from the model information obtained in step S803.

Specifically, for example, the manufacturer name “AAA”, the model name “PRINTER_B”, and a part of the serial number “12345” are used to determine the SSID as “AAA_PRINTER_B_12345”.

In step S805, the application A 322 performs a search for an AP with the SSID determined in step S804. Specifically, the application A 322 notifies the OS of the SSID determined in step S804 and thereby instructs the OS to search for an AP with that SSID. The search instruction executed at this time is different from the search instruction executed in step S605 or S1003. In response to this instruction, the OS searches for an AP notified of by the application A 322 and notifies the application A 322 of whether that AP has been discovered. In step S806, the application A 322 obtains information corresponding to the model name, that is, information related to the setup processing target model. In the present embodiment, the processing of step S805 and processing of step S806 are executed in parallel. However, the present invention is not limited to this form, and the processing of step S805 and processing of step S806 may be executed in order.

The AP search executed in step S805 is executed, for example, by passive scanning or by an active scanning method in which an SSID is specified. In addition, the obtainment of information related to the setup processing target model is performed by, for example, a method such as downloading from a server managed by the manufacturer. The information related to the model is, for example, a communication I/F type supported by that model, and a driver installer supporting that model. The driver installer corresponds to, for example, the application B 330.

In step S807, the application A 322 determines whether information related to the setup processing target model has been obtained. If it is determined that information related to the setup processing target model has not been obtained, in step S808 the application A 322 displays a screen (not illustrated) including a message indicating that the obtainment of information related to the setup processing target model has failed and then terminates the processing of FIG. 8. Meanwhile, if it is determined that information related to the setup processing target model has been obtained, the processing proceeds to step S809.

In step S809, the application A 322 determines whether an AP with the SSID determined in step S804 has been detected in the AP search in step S805. If it is determined that an AP with the SSID determined in step S804 has not been detected, in step S812 the application A 322 displays a setup screen in which a connection method supporting the setup processing target model can be selected and executes the setup processing. Then, the processing of FIG. 8 is terminated.

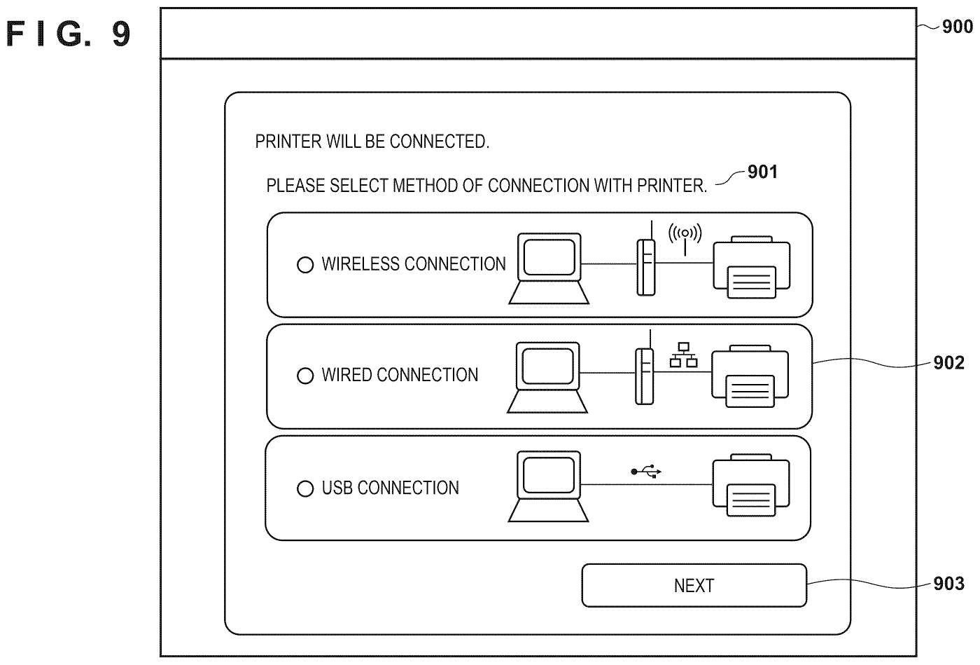

FIG. 9 is a diagram illustrating an example of a setup screen that is displayed in step S812 and in which a connection method can be selected. A connection method selection screen 900 includes a message 901 for guidance as to selection of a connection method for the printer, connection method selection items 902, and a button 903 for determining the connection method. Regarding the connection method selection items 902, a connection method can be selected from among, for example, USB connection, wired connection, and wireless connection, in the form of radio buttons. In addition, regarding the displayed selection items, display and non-display of the respective selection items are switched based on the information related to the setup processing target model, such as the type of communication I/F supported by the setup processing target model.

For example, when “wireless connection” is selected on the connection method selection screen 900, in step S812 processing including processing for setting a connection of a printer to a wireless LAN and print setting processing for the PC 101 is executed as the setup processing. The processing for setting a connection of a printer to a wireless LAN is processing in which the PC 101 temporarily connects with the target printer in network setup mode by P2P connection and transmits information on the SSID and the passphrase of an AP to which the PC 101 had been connected thus far and thereby causes the target printer to connect to that AP. The print setting processing for the PC 101 is, for example, processing for performing setting so as to allow start of use of the target printer with the PC 101 by activating the driver installer of the target printer.

For example, when “wired connection” is selected on the connection method selection screen 900, in step S812 processing including wired LAN connection processing for a printer and print setting processing for the PC 101 is executed as the setup processing. The wired LAN connection processing for a printer is, for example, process of performing setting for connection by LAN cable. The print setting processing for the PC 101 is, for example, processing for confirming whether a target printer is present in a LAN to which the PC 101 belongs and, if a target printer is present in the LAN, performing setting so as to allow start of use of the target printer with the PC 101 by activating the driver installer of the target printer.

For example, when “USB connection” is selected on the connection method selection screen 900, in step S812 processing including USB connection processing for a printer and print setting processing for the PC 101 is executed as setup processing. The USB connection processing for a printer is, for example, process of performing setting for connection by USB cable. The print setting processing for the PC 101 is, for example, processing for confirming that the PC 101 is connected with the target printer by USB cable and, if the PC 101 is connected with the target printer, performing setting so as to allow start of use of the target printer with the PC 101 by activating the driver installer of the target printer.

If it is determined that an AP with the SSID determined in step S804 has been detected, in step S810 the application A 322 stops displaying the processing-in-progress screen 701 and displays a confirmation screen 702 for the setup processing target model. The confirmation screen 702 is a screen for confirming with the user whether to execute the setup processing. The confirmation screen 702 displays information of a printer that is the setup processing target and includes an AP with the SSID determined in step S804. Specifically, for example, the serial number and the model name of the printer are displayed as the information of the printer. In addition, AP information to be transmitted to the printer in the setup processing is displayed on the confirmation screen 702. Specifically, for example, the SSID included in the AP information is displayed as the AP information. The AP information displayed here is specifically, for example, the AP information of an AP to which the PC 101 is currently connected.

In step S811, the application A 322 determines whether to execute the setup processing for the printer corresponding to the AP determined to have been detected in step S809. Specifically, for example, if an instruction to execute the setup processing has been received on the confirmation screen displayed in step S810, it is determined to execute the setup processing. If it is determined to not execute the setup processing, in step S812 the application A 322 displays a setup screen in which a connection method supporting the setup processing target model can be selected and executes the setup processing. Then, the processing of FIG. 8 is terminated. Meanwhile, if it is determined to execute the setup processing, the processing proceeds to step S813.

In step S813, the application A 322 executes the setup processing by wirelessly connecting to the setup processing target printer. Then, the application A 322 displays a screen 703 indicating that the setup processing is in progress. In step S813, processing including processing for setting a connection of a printer to a wireless LAN and print setting processing for the PC 101 is executed as the setup processing. The processing for setting a connection of a printer to a wireless LAN is processing in which the PC 101 temporarily connects with the target printer in network setup mode by P2P connection and transmits information on the SSID and the passphrase of an AP to which the PC 101 had been connected thus far and thereby causes the target printer to connect to that AP. The print setting processing for the PC 101 is, for example, processing for performing setting so as to allow start of use of the target printer with the PC 101 by activating a driver installer of the target printer. Then, the processing of FIG. 8 is terminated.

A case where the application A 322 is activated without the model information being included in the activation parameter will be described below.

FIG. 10 is a flowchart explaining normal setup processing of step S802 executed when the application A 322 is activated without the model information being included in the activation parameter. The processing of FIG. 10 is realized, for example, by the CPU 201 reading out a program stored in the ROM 202 to the RAM 206 and executing the program and will be described below as the processing of the application A 322 by the CPU 201.

First, FIG. 10 will be described with respect to a case where the application A 322 has been activated from the portal application 321 in step S802. In addition, transition of screens by the application A 322 will be described with reference to FIG. 5. The screens of FIG. 5 are an example, and the configuration of each screen is not limited to FIG. 5.

In step S1001, the application A 322 displays a printer power confirmation screen 501 of FIG. 5. The power confirmation screen 501 is a screen prompting the user to confirm that the printer 103 is powered on (turned on). When the power is turned on by the user following the message on the printer power confirmation screen 501, the printer 103 operates in network setup mode. Hereinafter, it is assumed that the printer has been powered on by the user.

In step S1002, upon a press of a next button on the power confirmation screen 501, the application A 322 searches for printers on a LAN to which the PC 101 belongs and displays a search-in-progress screen 502 of FIG. 5. In step S1003, processing for searching for APs existing around the PC 101 is executed. Specifically, the application A 322 instructs, for example, the OS, to search for APs existing around the PC 101. In response to this instruction, the OS performs a search for APs existing around the PC 101 and notifies the application A 322 of information on all discovered APs. Here, the search executed by the OS is a search executed by obtaining information (AP information) of nearby APs by passive scanning. In the present embodiment, the processing of step S1002 and processing of step S1003 are executed in parallel. However, the present invention is not limited to this form, and the processing of step S1002 and processing of step S1003 may be executed in order. Here, the search for printers on a LAN to which the PC 101 belongs is performed by, for example, Simple Network Management Protocol (SNMP) communication. A LAN to which the PC 101 belongs is a network formed by an AP to which the PC 101 is connected. The search for printers on a LAN in step S1002 is processing for obtaining information from a device on a LAN by SNMP and determining whether that device is the setup processing target printer based on that obtained information. The information obtained by SNMP is, for example, information such as a model name, a MAC address, an IP address, and a vendor identifier.

In step S1004, the application A 322 determines whether an AP corresponding to the SSID of a printer in network setup mode has been detected (discovered) by the search for APs existing around the PC 101. Since description for the determination in step S1004 is the same as that for step S606, the description thereof will be omitted. If it is determined that an AP corresponding to the SSID of a printer in network setup mode has been detected, the processing proceeds to step S1005, and if it is determined that an AP corresponding to the SSID of a printer in network setup mode has not detected, the processing proceeds to step S1013.

In step S1005, the application A 322 obtains model information from the SSID detected in step S1004. This processing is similar to the processing of step S607.

In step S1006, the portal application 321 determines, based on the model name obtained in step S1005, whether the printer transmitting the AP information including the SSID including the predetermined character string is a printer supporting the application A 322.

In the present embodiment, it is assumed that printers supporting the application A 322 and printers supported by the portal application 321 are the same. Therefore, this determination is similar to the processing of step S608. However, the present invention is not limited to this form, and for example, if the application A 322 and the portal application 321 are not packaged, some of the printers supporting the application A 322 and the printers supporting the portal application 321 may be different from each other.

If it is determined NO in step S1006, the processing of FIG. 10 is terminated. Meanwhile, if it is determined YES in step S1006, in step S1007 the portal application 321 displays a setup processing target confirmation screen 503 of FIG. 5. The confirmation screen 503 is a screen for confirming with the user whether to execute the setup processing. The confirmation screen 503 displays information of a printer that is the setup processing target and is the printer in network setup mode detected in step S1004. Specifically, for example, the serial number and the model name of the printer are displayed as the information of the printer. In addition, AP information to be transmitted to the printer in the setup processing is displayed on the confirmation screen 503. Specifically, for example, the SSID included in the AP information is displayed as the AP information. The AP information displayed here is specifically, for example, the AP information of an AP to which the PC 101 is currently connected.

In step S1008, the application A 322 determines whether to execute the setup processing for the printer corresponding to the AP determined to have been detected. Specifically, for example, if an instruction to execute the setup processing has been received on the confirmation screen 503 displayed in step S1005, it is determined to execute the setup processing. If it is determined to execute the setup processing, the processing proceeds to step S1009, and if it is determined to not execute the setup processing, the processing proceeds to step S1013.

In step S1009, the application A 322 obtains information corresponding to the model name, that is, information related to the setup processing target model and displays a processing-in-progress screen 504 of FIG. 5. Specifically, first, the application A 322 obtains model information (including a model name) from the detected SSID. Then, the application A 322 obtains information related to a model corresponding to the model name. Information related to a model is obtained by, for example, download from a server managed by the manufacturer. The information related to a model is, for example, a communication I/F type supported by that model, and a driver installer supporting that model. The driver installer corresponds to, for example, the application B 330. The information obtaining processing executed in step S1009 is similar to the information obtaining processing executed in step S806. However, whereas the information obtaining processing executed in step S1009 is executed after the confirmation screen 503 is displayed, the information obtaining processing executed in step S806 is executed before the confirmation screen 702 is displayed.

In step S1010, the application A 322 determines whether information related to the setup processing target model has been obtained. If it is determined that information related to the setup processing target model has not been obtained, in step S1012 the application A 322 displays a screen (not illustrated) including a message indicating that the obtainment of information related to the setup processing target model has failed. Then, the processing of FIG. 10 is terminated. Meanwhile, if it is determined that information related to the setup processing target model has been obtained, the processing proceeds to step S1011.

In step S1011, the application A 322 executes the setup processing by wirelessly connecting to the setup processing target printer. Since description for step S1011 is the same as that for step S813, the description thereof will be omitted. Then, the processing of FIG. 10 is terminated. In step S1011, the application A 322 displays a screen 505 of FIG. 5 indicating that the setup processing is in progress.

In step S1013, the application A 322 determines whether a printer has been detected on a LAN to which the PC 101 belongs as a result of the search in step S1002. Specifically, for example, if there is no response to communication from the PC 101 for a certain period or a plurality of times, it is determined that a printer has not been detected on a LAN to which the PC 101 belongs. If it is determined that a printer has not been detected on a LAN to which the PC 101 belongs, in step S1015 the application A 322 displays a setup screen in which a connection method in common among the models can be selected and executes the setup processing. Then, the processing of FIG. 10 is terminated. The setup screen displayed in step S1015 is, for example, the connection method selection screen 900 of FIG. 9, and is a setup screen in which display and non-display of the respective selection items is not switched so as to correspond to a particular model.

Meanwhile, if it is determined that a printer has been detected on a LAN to which the PC 101 belongs, in step S1014 the application A 322 executes the setup processing for the printer detected on the LAN. In step S1014, for example, processing for performing setting so as to allow start of use of the target printer with the PC 101 and processing for installing related applications and the like, are performed by activating the driver installer of the target printer. After step S1014, the processing of FIG. 10 is terminated.

As described above, in the present embodiment, the processing in the application A 322 and screen transition associated therewith are controlled so as to be different between activation where the model information is included in the activation parameter and activation where the model information is not included in the activation parameter. Specifically, in the case of activation where the model information is included in the activation parameter, a search for printers on a LAN to which the PC 101 of step S1002 of FIG. 10 belongs is not performed. Therefore, in that case, the search-in-progress screen 502 of FIG. 5 is not displayed. When the application A 322 is activated with the model information included in the activation parameter, the state is such that the target printer in network setup mode has already been identified. That is, since a search for printers on a LAN need not be performed, in the present embodiment the processing time for that case can be shortened by not performing the above search for printers on a LAN. In addition, screen transition can be optimized, allowing improvement in the convenience in processing for setting up the target printer.

In addition, in the case of activation where the model information is included in the activation parameter, display control is performed so as to not perform display of the printer power confirmation screen 501 in step S1001 of FIG. 10. When the application A 322 is activated with the model information included in the activation parameter, the state is such that the target printer in network setup mode has already been identified. That is, since a screen for guidance on causing the printer to enter network setup mode need not be displayed, in the present embodiment the processing time in that case can be shortened by not displaying the above power confirmation screen 501. In addition, screen transition can be optimized, allowing improvement in the convenience in processing for setting up the target printer.

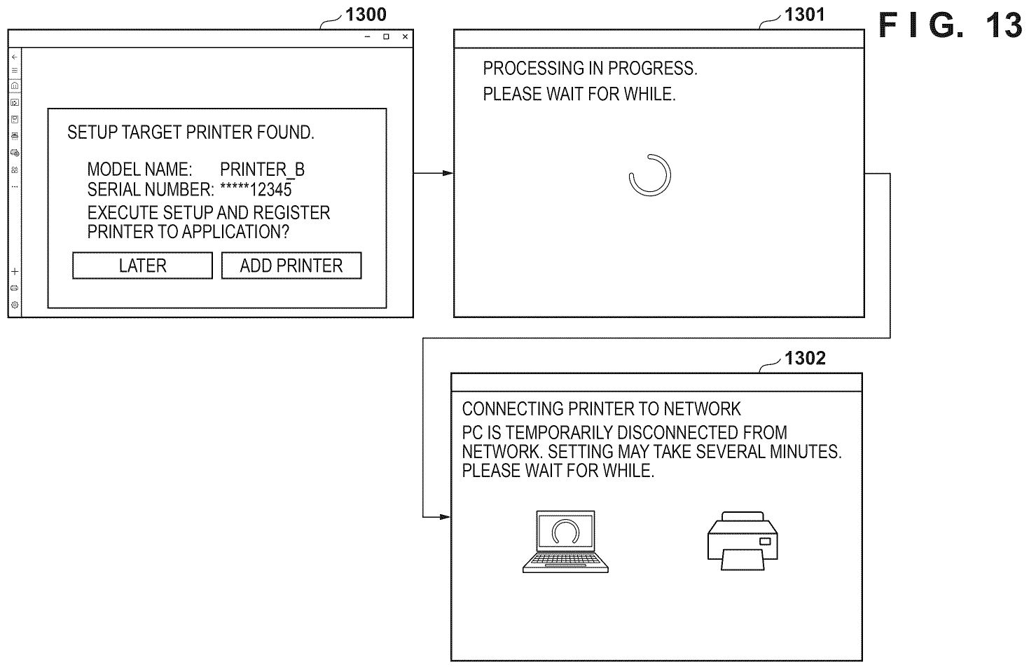

In the present embodiment, a configuration may be taken so as to not perform processing from step S803 to step S805 and step S809 to step S811 in the processing of FIG. 8. Such processing will be described below together with transition of screens in FIG. 13. The screens of FIG. 13 are an example, and the configuration of each screen is not limited to FIG. 13.

In step S609 of FIG. 6, the portal application 321 displays a setup guidance screen 1300 of FIG. 13. When a button by which an instruction selecting to perform a setup can be received is pressed on the setup guidance screen 1300, processing from step S801 onward in FIG. 8 is executed.

If it is determined in step S801 that the activation parameter includes model information, in step S806 the application A 322 obtains information corresponding to the model name, that is, information related to the setup processing target model. In step S807, the application A 322 determines whether information related to the setup processing target model has been obtained. In step S807, the application A 322 displays a processing-in-progress screen 1301 of FIG. 13.

If it is determined that information related to the setup processing target model has been obtained, in step S813 the application A 322 executes the setup processing by wireless connection for the setup processing target printer and displays a processing-in-progress screen 1302 of FIG. 13.

As described above, by not performing an AP search and screen display associated therewith, the processing time for when the application A 322 is activated with the model information included in the activation parameter can further be shortened. In addition, screen transition can be optimized, allowing improvement in the convenience in setting up the target printer.

### Second Embodiment

A second embodiment will be described below on points of difference from the first embodiment. In the first embodiment, a case where the portal application 321 searches for printers in network setup mode and executes processing for one detected printer in network setup mode has been described. Meanwhile, if there are a plurality of printers in an office environment or the like, a plurality of printers in network setup mode may be detected, in which case it is necessary to appropriately select the target printer. For example, by selecting a printer having a high signal strength, the communication state for when the user uses the printer will be good. Therefore, in the present embodiment, a configuration in which when a plurality of printers in network setup mode are detected, the portal application 321 performs setup processing for the target printer will be described.

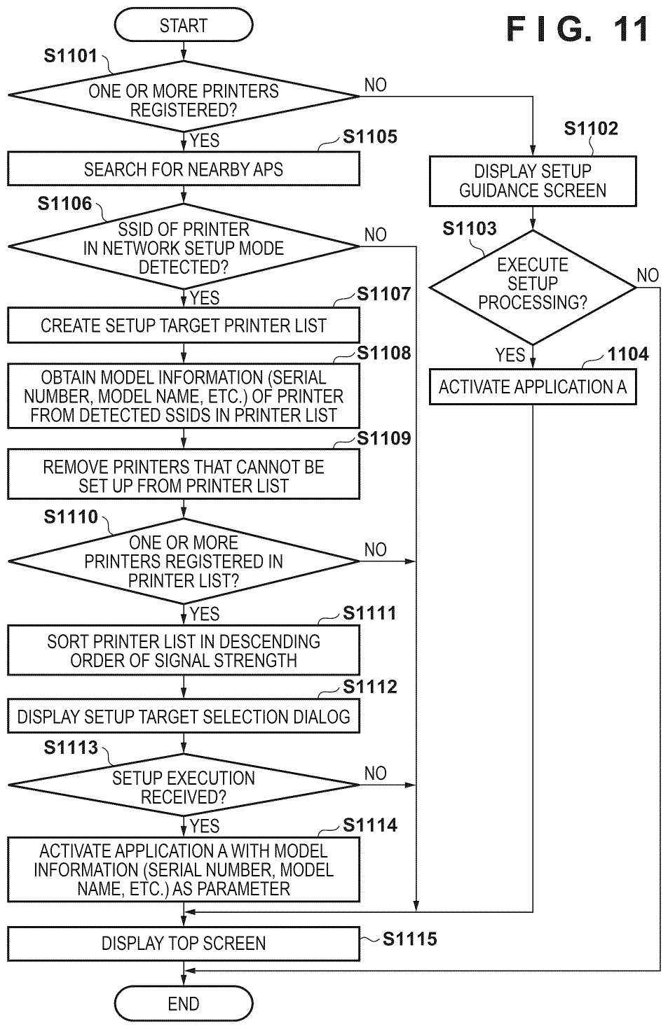

FIG. 11 is a flowchart for explaining processing for when the portal application 321 is activated according to the present embodiment. The portal application 321 starts the processing of FIG. 11 by receiving an activation operation by the user. The processing of FIG. 11 is realized, for example, by the CPU 201 reading out a program stored in the ROM 202 to the RAM 206 and executing the program and will be described below as the processing of the portal application 321 by the CPU 201.

Since description for step S1101 to step S1106 and step S1113 to step S1115 is the same as that for step S601 to step S606 and step S610 to step S612 of FIG. 6, the description thereof will be omitted.

If it is determined in step S1106 that one or more SSIDs of printers in network setup mode have been detected, the portal application 321 creates a setup target printer list based on the SSIDs detected in step S1107. Here, it is assumed that a plurality of SSID are detected.

In step S1108, the portal application 321 obtains model information of all the printers in network setup mode from the printer list created in step S1107. Here, the obtained model information is, for example, the model name and a part of the serial number. The model information is obtained similarly to the description of step S607.

In step S1109, the portal application 321 deletes, from the printer list, printers that are not supported by the setup processing. Specifically, for example, it is determined whether a corresponding model name is included in a list of setup processing-supported model names predetermined in the portal application 321. Alternatively, a configuration may be taken so as to reference a list of setup processing-supported model names predetermined in the application A 322 and determine whether a corresponding model name is included.

In step S1110, the portal application 321 determines whether one or more printers are registered in the printer list. If it is determined that not even one printer is registered in the printer list, the processing proceeds to step S1115. Meanwhile, if it is determined that one or more printers are registered in the printer list, the processing proceeds to step S1111.

In step S1111, the portal application 321 reorganizes (sorts) the printers in the printer list in a descending order of signal strength. Here, signal strengths are obtained by, for example, passive scanning when searching for printers in network setup mode in step S1105. A signal strength is represented by a value indicated by a Received Signal Strength Indicator (RSSI), for example, in which case a greater value indicates a greater signal strength.

In step S1112, the portal application 321 displays a setup target printer selection screen.

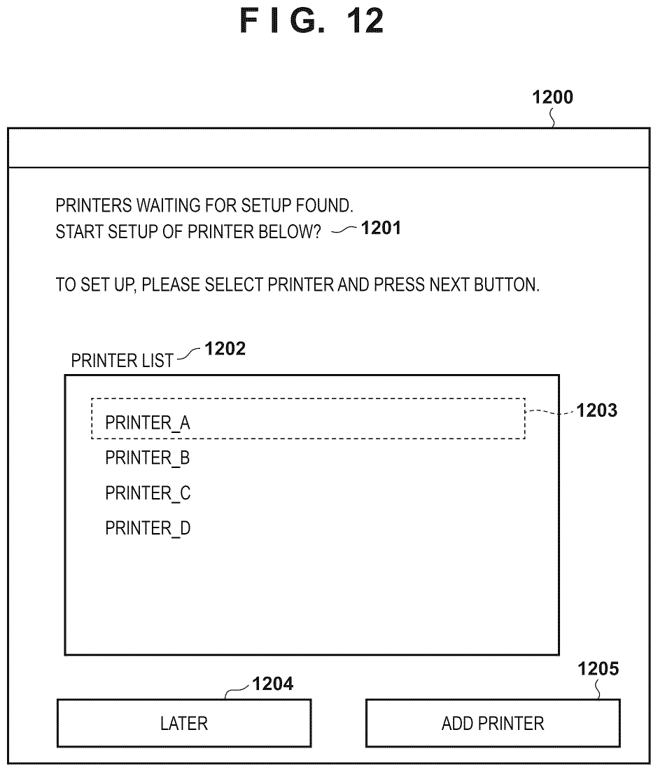

FIG. 12 is a diagram illustrating an example of the setup target printer selection screen displayed in step S1112. A setup target printer selection screen 1200 includes a message 1201 prompting selection of the setup processing target printer, a setup processing target printer list display region 1202, and a printer determination region 1203. The setup target printer selection screen 1200 includes a button 1204 by which a selection operation for not executing the setup processing can be received and a button 1205 by which a selection operation for executing the setup processing of a printer determined using the printer determination region 1203 can be received. The printer determination region 1203 can be moved up and down in response to a user operation and can be moved to a position desired by the user.

In step S1113, the portal application 321 determines whether a setup processing execution instruction has been received on the setup target printer selection screen 1200. Specifically, for example, when a press of the button 1205 is received, it is determined that a setup processing execution instruction has been received. In step S1113, if it is determined in that a setup processing execution instruction has been received, the processing proceeds to step S1114, and if it is determined that a setup processing execution instruction has not been received, the processing proceeds to step S1115.

In step S1114, the portal application 321 activates the application A 322 with the model information obtained in step S1108 included in the activation parameter. That is, the application A 322 is activated with information including the model name and a part of the serial number included in the activation parameter. The activation of the application A 322 where the model information is included in the activation parameter is, in other words, passing of the model information to the application A 322 when activating the application A 322. Then, in step S1115, the portal application 321 displays the top screen 400. Then, the processing of FIG. 11 is terminated.

In the present embodiment, the printers in the printer list are reorganized in descending order of signal strength in step S1111, but a configuration may be taken so as to remove printers whose signal strengths are less than or equal to a threshold predetermined in the portal application 321 from the list.

As described above, according to the present embodiment, the portal application 321 detects a plurality of printers in network setup mode and prompts the user to select a setup target printer based on the signal strengths of the detected printers. With such a configuration, it is possible to perform setup processing suitable for the environment in which a printer is installed.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-047092, filed Mar. 22, 2024, which is hereby incorporated by reference herein in its entirety.

What is claimed is:

1. A method of controlling an information processing device including a first program and a second program, the method comprising:
executing, by the first program, first search processing for searching for a communication device operating in a predetermined mode for receiving setting information from the information processing device;
providing, by the first program, the second program with information related to the communication device discovered by the first search processing; and
executing, by the second program, transmission processing without executing, by the second program, second search processing, the transmission processing being for transmitting information related to an external access point to the communication device identified based on the information related to the communication device discovered by the first search processing and the second search processing being for searching for the communication device on a network to which the information processing device belongs.

2. The method according to claim 1, further comprising:
in a case where the information related to the communication device discovered by the first search processing has not been provided to the second program from the first program, executing, by the second program, the second search processing; and
executing processing for using, from the information processing device, the communication device discovered by the second search processing executed by the second program.

3. The method according to claim 2, wherein
in a case where the communication device is not registered in the first program, the information related to the communication device discovered by the first search processing is not provided to the second program from the first program by the first search processing not being executed by the first program.

4. The method according to claim 3, further comprising:
in a case where the communication device is not registered in the first program, executing, by the first program, processing for activating the second program without executing the second search processing by the first program.

5. The method according to claim 2, further comprising:
in a case where the information related to the communication device discovered by the first search processing has not been provided to the second program from the first program, executing, by the second program, the first search processing.

6. The method according to claim 5, wherein
in a case where the communication device is discovered by the first search processing executed by the second program, the transmission processing is executed by the second program, and
in a case where the communication device is not discovered by the first search processing executed by the second program, processing for using, from the information processing device, the communication device discovered by the second search processing executed by the second program is executed.

7. The method according to claim 1, wherein
in a case where the communication device is registered in the first program, the first search processing is executed by the first program.

8. The method according to claim 7, further comprising:
in a case where the communication device is registered in the first program, after executing the first search processing by the first program, executing, by the first program, processing for activating the second program.

9. The method according to claim 8, wherein
the information related to the communication device discovered by the first search processing is provided to the second program by the first program by the information related to the communication device discovered by the first search processing being included in an activation parameter for activating the second program.

10. The method according to claim 1, further comprising:
in a case where the information related to the communication device discovered by the first search processing has not been provided to the second program from the first program, executing, by the second program, third search processing, which is processing for searching for the communication device operating in the predetermined mode and is processing that is different from the first search processing, by using the information related to the communication device discovered by the first search processing,
wherein the communication device identified based on the information related to the communication device discovered by the first search processing is the communication device discovered by the third search processing.

11. The method according to claim 10, further comprising:
executing download processing for downloading, from a server external to the information processing device, information related to a model of the communication device discovered by the first search processing,
wherein the third search processing and the download processing are executed in parallel.

12. The method according to claim 11, wherein
the information related to the model of the communication device discovered by the first search processing includes at least one among information related to an interface supported by the model of the communication device discovered by the first search processing and a driver installer supporting the model of the communication device discovered by the first search processing.

13. The method according to claim 10, further comprising:
in a case where the communication device has been discovered by the third search processing, displaying a screen including information indicating the communication device discovered by the third search processing and information indicating the external access point to which the information processing device is connected.

14. The method according to claim 1, wherein
the first search processing includes processing for searching for one or more access points existing around the information processing device and processing for detecting an access point corresponding to the communication device operating in the predetermined mode from among the discovered one or more access points.

15. The method according to claim 1, further comprising:
in a case where the communication device has been discovered by the first search processing, displaying, by the first program, a screen including the information indicating the communication device discovered by the first search processing,
wherein in a case where a predetermined operation has been performed on the screen, the information related to the communication device discovered by the first search processing is provided to the second program.

16. The method according to claim 1, wherein
the information related to the communication device discovered by the first search processing that is provided to the second program includes at least one among a model name of the communication device and a serial number of the communication device.

17. The method according to claim 1, wherein
the communication device is a printer.

18. The method according to claim 1, further comprising:
transmitting, by the first program, a print job for causing the communication device to execute printing to the communication device registered in the first program.

19. An information processing device including a first program and a second program, the information processing device comprising at least one memory and at least one processor,
the at least one memory and least one processor causing the information processing device to operate as:
a first execution unit configured to execute, by the first program, first search processing for searching for a communication device operating in a predetermined mode for receiving setting information from the information processing device;
a provision unit configured to provide, by the first program, the second program with information related to the communication device discovered by the first search processing; and
a second execution unit configured to execute, by the second program, transmission processing without executing, by the second program, second search processing, the transmission processing being for transmitting information related to an external access point to the communication device identified based on the information related to the communication device discovered by the first search processing and the second search processing being for searching for the communication device on a network to which the information processing device belongs.

20. A non-transitory computer-readable storage medium that stores one or more programs including instructions, which when executed by one or more processors of an information processing device including a first program and a second program, causing a computer of the information processing device to:
execute, by the first program, first search processing for searching for a communication device operating in a predetermined mode for receiving setting information from the information processing device;
provide, by the first program, the second program with information related to the communication device discovered by the first search processing; and
execute, by the second program, transmission processing without executing, by the second program, second search processing, the transmission processing being for transmitting information related to an external access point to the communication device identified based on the information related to the communication device discovered by the first search processing and the second search processing being for searching for the communication device on a network to which the information processing device belongs.
